(19) United States
(12) Patent Application Publication
(10) Pub. No.: US 2018/0192637 A1
(43) Pub. Date: Jul. 12, 2018

(54) INVERTIBLE DECOY

(71) Applicant: Brendan Vaughan Chapman, Canora (CA)

(72) Inventor: Brendan Vaughan Chapman, Canora (CA)

(21) Appl. No.: 15/865,578

(22) Filed: Jan. 9, 2018

(30) Foreign Application Priority Data
Jan. 9, 2017 (CA) 2953986

(51) Int. Cl. A01M 31/06

(52) U.S. Cl. CPC A01M 31/06

(57) ABSTRACT

A decoy is provided having a reversible body having a top end and a bottom end with an opening in the bottom end, an outer side displaying a first animal and an inner side displaying a second animal. The decoy is transformed from displaying the first side and the first animal to displaying the second side the second animal by inverting the reversible body. A head can be provided at the top end of the body that is a double-faced head with a first end corresponding to the first animal and a second end opposite to the first and corresponding to the second animal. Relief channels can be provided in the body to improve the ability of the body to be inverted.

### REFERENCE TO RELATED APPLICATION

This application claims priority to Canadian Applic. No. 2,953,986, filed on Jan. 9, 2017, the contents of which are incorporated herein by reference.

### FIELD OF THE INVENTION

This invention is in the field of hunting equipment, and more specifically, to hunting decoys.

### BACKGROUND

Animal decoys are used to attract and/or repel live animals for various purposes. Decoys imitate the look of animals so as to fool other animals (either the same or different) into thinking that the decoy is the real animal that the decoy is meant to imitate.

Decoys that imitate the size and look of a predator can be used to repel other animals that are the predator's prey and that can otherwise damage property. An example of this might be the use of an owl decoy or a hawk decoy that will keep smaller birds and rodents away from the property, which might otherwise fly into windows and be injured themselves, or which could destroy gardens and berry bushes.

Another example are field decoys, which are sometimes used to attract animals for observation or for hunting. Hunting decoys mimic the size and look of real prey so as to fool other animals such as predators into coming close enough for hunters to harvest them. Other times, the animal depicted on the decoy represents an animal of a specific species that a sportsman is pursing on a hunt. For example, wildfowl or waterfowl decoys are used to attract waterfowl such as geese and ducks into coming within shooting range. Ducks and geese are particularly prone to be attracted to a decoy or decoys having coloration simulating their own species. As such, experienced sportsman will often put out decoys of the particular species they wish to attract. When waterfowl see decoys imitating undisturbed waterfowl, they can feel more comfortable getting closer to the undisturbed waterfowl where the sportsman might be waiting nearby.

There are many different types of field hunting decoys, and specifically of waterfowl decoys. For example, there are both land decoys for geese and water decoys for geese.

Land decoys are generally used exclusively on land and are typically made out of plastic. They come in either a shell or full-body form. A full-body decoy is typically a life-sized replica of a duck or goose (although some can be larger or smaller) and frequently comes with a motion stake that can allow the decoy to move in a somewhat natural manner with any sort of wind, but that will prevent the decoy from flying away in heavier winds. A shell decoy, on the other hand, represents the back and sides of a duck or goose and look like the goose or duck is sitting on the ground with its legs tucked up underneath it. Shell decoys do not have a belly or legs so they are usually cheaper to make and easier to ship to consumers. They are also easier for an owner to transport and store as compared to the more realistic-looking full-body counterpart.

A water decoy or floating decoy is a decoy designed to float on water. They are generally made of plastic and have a keel, as well as an anchor and cord to prevent the decoy from floating away. Some water decoys also have small battery-operated motors to allow the decoys to “swim” or vibrate to create ripples in the water replicating an ‘active’ flock of waterfowl socializing in a body of water.

Waterfowl have become more aware of decoys in recent years. As such, hunters require very realistic-looking decoys to dupe waterfowl into coming closer. An example of this is the evolution of Canadian Goose decoys. Canadian goose decoys were originally plastic shell decoys or two-dimensional silhouettes that were not very convincing and the focus was on the size of the decoy so as to allow the decoy to be more readily seen by passing geese. Those same decoys would not work with cautious Canadian geese today, as Canadian geese will readily recognize a fake, unrealistic-looking Canadian goose. To compensate, ultra-realistic decoys have been developed.

Transportation, maintenance, and storage of conventional realistic-looking decoys is difficult and requires an enormous amount of storage space. Decoys can be large and can take up a lot of cargo space and can also be very heavy. This can be particularly problematic when the field where the hunt is to take place must be reached on foot, such that the decoys must be carried long distances. These problems are exacerbated by the fact that a collection of different decoys for different wildfowl and four different seasons or conditions is desirable for allowing a variety of year-round hunting. For example, using conventional hunting decoys, if a user wants to hunt both Canadian geese and snow geese, the user is required to purchase a separate decoy for each species and must carry them all with him or her on a hunt, which can be problematic if the spread is to be laid out a long distance from base camp.

Purchasing so many decoys is also very expensive. Currently when hunting waterfowl, a significant financial investment must be made into hunting blinds, camouflage, shotgun, static decoys, motion decoys, flappers, calls, etc. Furthermore, if you want to hunt different species, you must have different static decoys, motion decoys, flappers, and calls for each species you are hunting. This can make it virtually impossible for avid hunters to participate in the harvesting of multiple waterfowl species. Decoys are typically limited to depiction of a single species of waterfowl, thus requiring a plurality of decoys of different species if the sportsman is desirous of attracting different species of waterfowl. A decoy spread can often consist of more than forty or fifty decoys during one hunt. Such a spread could include several different species and sex types of full-bodied decoys. While single species shell decoys are cheaper per dozen than full-bodied decoys, the fact that several decoys are required for a complete spread can mean that the decoys alone can cost thousands of dollars. The transportation and maintenance of such a large number of decoys is also very expensive. Furthermore, conventional decoys' realistic appearance can diminish over time as the markings on the decoys weather, meaning that the decoys need to be replaced regularly, as often as 5 or 6 years, depending on wear and tear. This can be prohibitively expensive.

One of the problems the hunter or sportsman faces is that of changing the decoys when he or she wishes to attract a different species of waterfowl. In this regard, the sportsman may wish to change a decoy so as to change its coloration to simulate different species. Changing a decoy spread is not only time consuming but detracts from the enjoyment of the hunt, and also requires additional decoys to be carried or transported to the hunting area.

Some attempts to address these issues have used removable and variable slip covers over a decoy body that can allow for the display of different species. This cover concept is time-consuming and requires that a large number of separate covers be carried by the hunter, as well as does not address the large number of decoy bodies that need to be stored and transported. These covers are also unrealistic in appearance. As discussed, one of the major difficulties in fooling waterfowl is that they can readily identify fake-looking decoys and if the decoys do not look sufficiently realistic, shy birds will not be encouraged to move within shooting distance of the sportsman.

It is desirable to have an animal decoy that can cut down on the number of decoys required to be purchased, stored, transported, and carried by depicting different species, sex, age, and/or seasonal plumage on a single body, but that is also realistic in appearance. It would also be desirable if the animal decoy was easily transportable and could allow for easily and quickly changing a hunting spread.

### SUMMARY OF THE INVENTION

In an aspect, a decoy is provided having a reversible body having a top end and a bottom end with an opening in the bottom end, an outer side displaying a first animal and an inner side displaying a second animal. The decoy is transformed from displaying the first side and the first animal to displaying the second side the second animal by inverting the reversible body.

It would be advantageous to have an animal decoy that is versatile, but that retains the lifelike appearance and effectiveness of traditional decoys. It would also be advantageous to have an animal decoy that allows for the quick and inexpensive ability to change the species and/or sex of the animal replicated by the decoy in the field quickly and that is easy to set up. It would furthermore be advantageous to have a decoy that allows for weathered markings to be refreshed.

The present invention can allow for an animal decoy to be turned inside-out to allow for one decoy to take the place of two decoys. This can provide a user with a cost-effective way to hunt various species or game, as it keeps the user from having to purchase a different decoy for every desired species, sex, age, or seasonal plumage. This can also allow for easier transport of multiple decoy gender, species, or genome as compared to carrying two or more decoys or returning to base camp every time the user wants to exchange the decoy being used. This is also advantageous in providing the user with the ability to quickly and easily change the decoy when desired, wherever desired. The present invention can also allow for retention of a realistic appearance, as the decoy can retain a 3-dimensional shape, regardless of which of the two sides of the decoy are used, and can reduce wear on the decoy as there is only one side of the decoy exposed at any time while in use.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a schematic view of an invertible decoy in an aspect, showing an outer surface;

FIG. 2 is a schematic view of the invertible decoy shown in FIG. 1, with the body of the decoy inverted to show an inner surface of the decoy;

FIG. 3 is a schematic view of the bottom of the invertible decoy shown in FIG. 1;

FIG. 4 is a schematic view of the invertible decoy shown in FIG. 1 with a keel; and

FIG. 5 is a schematic view of the invertible decoy shown in FIG. 1 with a keel.

### DETAILED DESCRIPTION OF THE ILLUSTRATED EMBODIMENTS

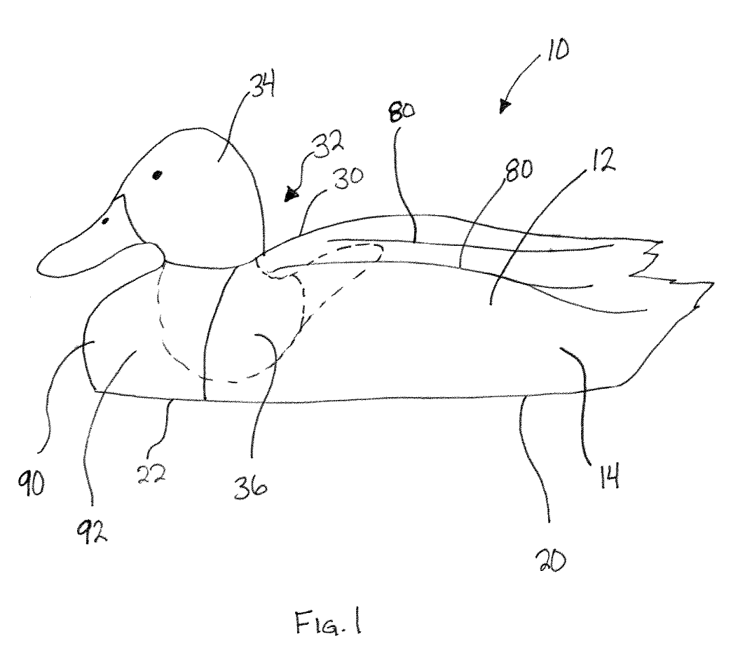

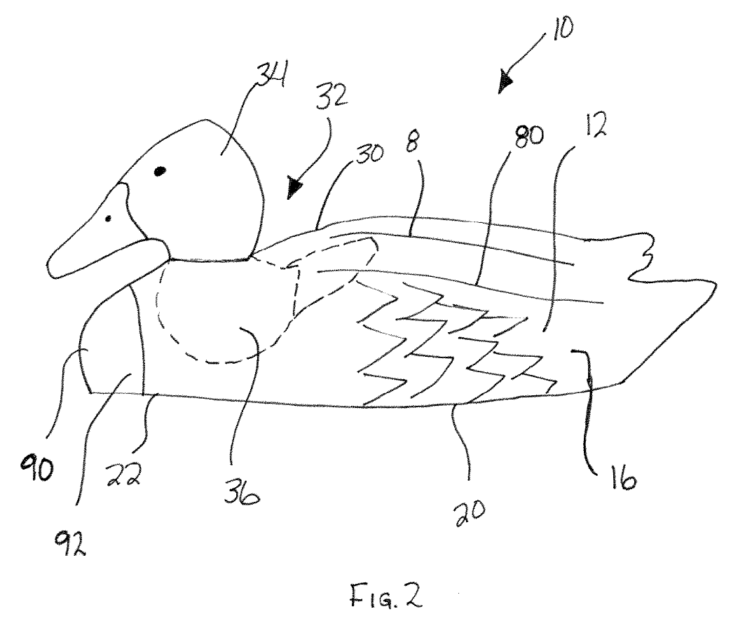

FIGS. 1 and 2 illustrate a decoy 10 in an aspect. The decoy 10 is invertible so that it can allow for a more economical and easier way to hunt two species from one set of decoys. A sportsman can purchase one set of decoys for two species instead of an individual set for each species and can allow for the quick changing of one species to an alternative species. In this way, the sportsman only needs to carry and store half of the number of decoys they might otherwise need to carry on trips that require long walks.

The decoy 10 depicts a shaped three-dimensional appearance of a first animal on a first side surface or outer side 14, as shown in FIG. 1, and a shaped three-dimensional appearance of a second animal on a second side surface or inner side 16 that is opposed to the outer side 14 when the decoy 10 is reversed inside-out, as shown in FIG. 2. The depiction of the animals could lure the corresponding real animals nearer or could repel other animals, such as corresponding prey, away.

In some aspects, a decoy could resemble wildfowl game or prey being hunted, such as by depicting any sort of wildfowl or avian species, including geese, ducks, owls, hawks, turkeys, pheasants, dove, quail, and nearly any other species of bird. This can allow a sportsman to hunt different species including but not limited to Canada geese, snow geese, speckle belly geese, blue geese, and brant geese. In the aspect shown, decoy 10 provides distinctive colouring and characteristics of a first waterfowl species and a second waterfowl species, depending on whether in outer side 14 or the inner side 16 of the decoy 10 is showing.

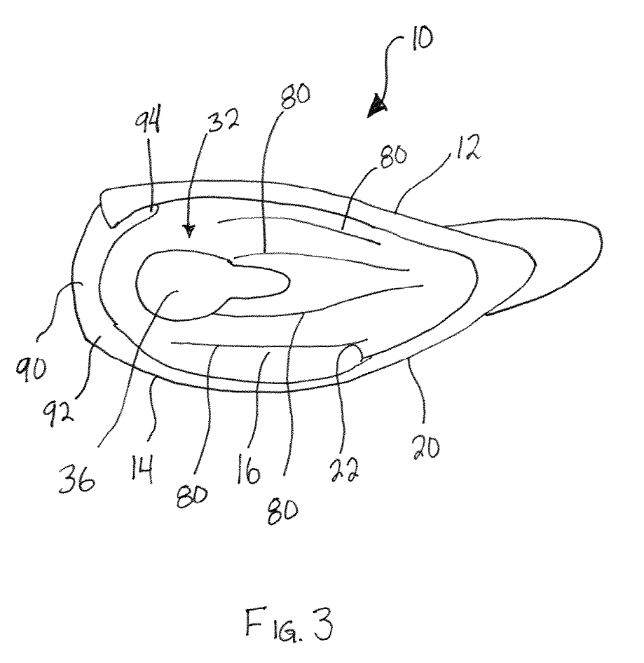

Decoy 10 comprises a hollow reversible main body 12 that is a three-dimensional depiction of the body, breast, and wings of two wildfowl, with one wildfowl shown on the outer side 14 and another one shown in the inner 16 of the reversible body 12. Referring to FIG. 3, the main body 12 can have an opening 22 at a bottom end 20 of the body 12.

Referring again to FIGS. 1 and 2, a rotatable double-faced head 32 can be disposed at a top end 30 of the body 12. The body 12 could be made out of silicone, a rubber-based material, a polymer, fabric or another flexible material that can allow the walls of the body 12 to be pushed through the opening 22 so as to turn the body 12 inside-out. The molding and coloration of the main body 12 is such that when it is turned inside-out, a different species or sex of land or water fowl becomes visible. This flexible reversible shell body 12 can allow for the easy conversion from the outer side 14 of the body 12 to the inner side 16 of the body 12 to represent another species or sex of a water or land fowl. For example, the outer side 14 of the body 12 could depict a Canada goose, and the inner side 16 of the body 12 could depict a snow goose. The body 12 could be inverted through the opening 22 by pushing the body 12 therethrough, thereby allowing the decoy 10 to be selectively converted from the snow goose to the Canada goose and back again.

It is understood that the decoy could be transformable into different types of game and gender of game, so long as the animals depicted are of roughly the same general size on opposing sides. The decoy could also relate to animals aside from birds such as deer, elk, moose, bear, and any other animal for which decoys can be made. In some aspects the decoy could represent varmint prey or could be a small animal like a rabbit or rodent. For example, a first surface of a decoy body could depict a squirrel, which could be converted to another type of ground dwelling animal by exposing the second surface of the decoy body. This can allow a single decoy body to be used to create two different animals or species.

The outer side 14 and inner side 16 can represent different species, and also alternative sex, age, seasonal plumage, positioning, and other characteristics of the wildfowl depicted. Furthermore, a decoy could display either different species, sex, age, seasonal plumage, positioning, etc. on the different sides of the decoy, or in some cases could display the same physical characteristics on both sides of the decoy when a sportsman simply wishes to refresh a weathered look of the decoy by turning it inside-out. In some aspects, the inner side 14 and the outer side 16 of the body 12 can have markings disposed thereon to depict a variety of species and poses to make the spread look natural and relaxed. When inverted, a different species or pose of water fowl can be visible.

The use of a single wildfowl body 12 in forming any one of a variety of different wildfowl decoys can enable a hunter to adapt, on-the-fly, to different hunting characteristics where different species may be present by simply inverting the body 12 of the decoy 10. As a further example, a decoy body could have markings depicting a duck on each opposing surface, which could be of the same genus and the same species of duck, but may be of a different gender of a duck. This could allow a sportsman to adapt, on-the-fly, two different hunting characteristics when a female or male wildfowl gender is desirable to attract wildfowl targets.

The body 12 could be constructed out of a suitable waterproof flexible plastic, a silicone, a rubber material, another polymer, fabric or any suitable waterproof flexible material. This could allow the decoy 10 to be generally foldable, compressible, and/or collapsible. The generally hollow body 12 could allow the body 12 to act as somewhat of a shell such that it is lightweight and crushable for transportation and storage. For example, the use of silicone for the body 12 and its general hollowness can allow for easy transport, as the silicone decoy 10 can be depressed to allow more decoys 10 to be fit into a small space. The flexibility of the same can allow inversion of the decoy body 12, while maintaining durability in a variety of environmental conditions.

In some aspects, the body 12 can be strengthened and/or reinforced to provide flexible resiliency. Use of a sheet of fabric between coats of materials can be used for strength and durability similar to fiberglass, without sacrificing flexibility. A rubber body 12 could be strengthened by the use of one sheet fabric between coats of rubber, to which the rubber adheres. Such reinforcement could be placed around the whole of the body 12, or could be provided in only areas that are made up of thinner rubber.

In an aspect, spring steel sheet can positioned within the dorsal body 12 to encourage a ‘snapping’ into shape action and to act as a type of endoskeleton for the body 12. This could allow for a more natural snapping into place of the body 12 as it is inverted inside-out, or as it decompresses from storage or transportation.

The outer side 14 of the body 12 can be molded, painted, decorated, or ornamented to simulate one species of a duck or goose or other avian specie. The inner side 16 of the body 12 can be molded, painted, decorated, or ornamented to simulate a different species of duck or goose or other avian specie. The outer side 14 of the main body would be suitably painted, decorated, or ornamented to simulate, for example, the plumage of a snow goose. The inner side 16 of the same body 12 would be painted, decorated, or ornamented to simulate, for example, the plumage of a Canadian honker goose. The outer side 14 of the decoy body 12 can have markings that could depict the same or different species or sex simulated by the inner side 16 of the decoy body 12.

Due to the flexible nature of the body 12 material and the opening 22 at the bottom end 20 of the body 12, a user can invert the decoy 10 so that either the outer side 14 or the inner side 16 is visible. The decoy 10 is thus selectively reversible so that a user can select the species or sex of animal to be visible and thus can easily and inexpensively provide two decoys of different species or sex using a single decoy.

Because the decoy 10 will typically be molded, the decoy 12 will be molded with the outer side 14 facing outwards while the inner side 16 faces inwards. This can cause the decoy 10 to naturally favor or “work better” when it is positioned with the outer side 14 facing outwards and its inner side 16 facing inside. This is because the molded material of the body 12 will favor this shape because when it is placed in this position neither the surface of the outer side 14 nor the surface of the inner side 16 will be placed in either tension or compression because the body 12 was molded in this position. However, when the body 12 is inverted so that the inner side 16 faces outwards and the outer side 14 faces inwards, the surface of the inner side 16 will be placed in tension because it will be stretched to form an outer surface while the outer side 14 is placed in compression. This can cause the curvature of the back and sides of the decoy 10 to not be shaped right and look “funny” when the body 12 has been inverted and the inner side 16 is facing outwards.

To relieve this situation of tension of the inner side 16 when the decoy 10 is in the inverted position with the inner side 16 facing outwards, one or both of the following features can be provided: relief channels 80 in the body 12 of the decoy; and a flap 90 at the front of the body 12 of the decoy 10.

When the decoy 10 is positioned with the outer side 14 facing outwards as the decoy 10 was molded, there will be an curve formed over the back of the decoy 10; running generally from one side of the opening 22 over the back of the decoy 10 and down the other side to the other side of the opening 22. When the outer side 14 is facing outwards this curve is formed naturally by the body 12 of the decoy 10 because the decoy 10 was molded in this position. However, when the body 12 of the decoy 10 is inverted, this curve can be distorted and pulled out of shape by the tension in the inner side 16 which is now facing outwards. Relief channels 80 can be provided in the body 12 of decoy 10 to relieve the tension formed when the body 12 of the decoy 10 is inverted. In one aspect, these relief channels 80 can be provided in the sides of the body 12. This relief channels 80 can just penetrate the surface of the inner side 16 and not pass completely through the material, or they could penetrate right though the outer side 14 as well. Typically, these relief channels 80 will run horizontally and approximately perpendicular to the curve over the back of the decoy 10. In one aspect, if the decoy 10 is for a waterfowl or other game bird, the relief channels 80 can be provided along where the wings are represented on the decoy 10 so that the relief channels 80 are hidden by the lines of the wings.

The relief channels 80 can allow the body 12 of the decoy 10 to separate slightly and relieve or even remove tension in the inner side 16 of the body 12 when the body 12 is inverted so that the inner side 16 is facing outwards. In this manner, rather than the inner side 16 being placed in tension and the curvature of the back of the body 12 being distorted by this tension placed on the inner side 16 of the body 12, the relief channels 80 can allow the surface of the inner side 16 to separate at these relief channels 80 and relieve the tension in the inner side 16 and allow the inner side 16 to from a more natural looking curvature over the back of the body 12 when it is inverted.

While the relief channels 80 are meant to reduce or even remove any tension in the inner side 16 of the body 12 of the decoy 10 caused by the curvature of the body 12 over the back of the decoy 10, the flap 90 can be used to reduce any tension in the body 12 of the decoy 10 in the curvature formed around the periphery of the opening 22 and in the sides of the body 12.

In addition to the curvature of the body 12 of the decoy 10 over it back, the body will also have a curvature around the periphery of the opening 22 and the sides of the body 12 of the decoy 10. When the body 12 in inverted so that the inner side 16 is facing outwards, the body 12 the inner side 16 can be placed in tension causing the curvature around this periphery and the sides of the body 12 to look odd and unnatural. The flap 90 can be provided at the front of the body 12 of the decoy 10 that can reduce the tension in the inner side 16 around this periphery and the sides of the body 12. At the front of the body 12 of the decoy 10, the flap 90 can be provided that is connected to the body 12 on a first end 92 but not on a second end 94. If the decoy 10 is a waterfowl or other bird, the flap 90 could form the chest of the bird. The flap 90 can be longer than the opening in the body 12 of the decoy 10 that the flap 90 covers so that the flap 90 can be tucked behind and inside the body 12 of the decoy 10, as shown in FIG. 3, when the decoy is in use. A latching mechanism, provided proximate a second end 94 of the flap 90, such as a magnet, can be used to hold the flap 90 in place.

When the body 12 of the decoy 10 has the outer side 14 facing outwards and the inner side 16 facing inwards, the second end 94 of the flap 90 can be tucked in behind the body 12 of the decoy 10 so that it gives the appears of the animal it is trying to represent. Then when the body 12 is inverted so that the inner side 16 is facing outwards, the flap 90 which is not connected at the second end 94, can be tucked back inside the body 12 of the decoy 10 and again fixed in place to form the chest (if the decoy 10 is representing a bird). By having this flap 90 not connected to the body 12 at the second end 94, the flap 90 forms a break in the periphery of the body 12 around the opening 22 and will reduce the tension or even eliminate it in the inner side 16 around the opening 22 and in the sides of the decoy 10 when the body 12 is inverted.

The method of including markings or detail on the body 12 can depend on the production method and must be suitable and compatible with the materials making up the body 12. In some aspects, each surface 14, 16 could have molded-in feather detail and could depict wings of the species. Molded-in markings can allow for durability of the species' details when exposed to the environment. The details could also be carved into the material. In some aspects, the colouring and markings could be applied to the decoy body 12 using many different known methods and materials. For example, various inks, paints and dyes can be brushed, sprayed or silk-screened onto the decoy 10. In one aspect, the body 12 may be made of a fabric on which colour schemes are printed. The material could be printed with a photograph or graphic design art which could be painted on or impregnated and could be made as high a quality as to be similar to a photograph.

When used, the decoy 10 can have markings that can get weathered, which would include fading, chipping, scratching, or other types of marring of the markings through age, use or other external force. By inverting the decoy 10 to show the outer side 14 or the inner side 16 of the body 12, the user can refresh the weathered appearance of the decoy 10 and restore its realistic appearance by inverting the body 12 to expose the inner side 16 that has not been subjected to the weather as long as the outer side 14 of the decoy 10.

In some aspects, the appearance of the decoy 10 can be protected from outdoor elements through the use of a coating on the decoy body 12. For example, a super hydrophobic water repellant can either be impregnated within the body 12 material, for example, within the rubber or silicone, or could be used to coat the outer side 14 and the inner side 16. The coating can be used to stop frost from developing on the decoy 10 which in turn could provide a warning to targeted birds via reflection from the sun.

A rotatable double-faced head 32 is disposed at a top end 30 of the body 12. The double-faced head 32 can have a first end 34 resembling the head and neck of an animal corresponding to the outer side 14 of the body 12, and a second end 36 opposite the first end 34 resembling the head and neck of an animal corresponding to the inner side 16 of the body 12. For example, the first end 34 could be painted, decorated, or ornamented to simulate one species of a duck or goose and the second end 36 could be painted, decorated, or ornamented to simulate another species of a duck or goose. FIGS. 1 and 2 show the decoy 10 with one of the heads corresponding to one of the inner side 16 shown in phantom. Each end 34, 36 resembling the head and neck of an animal could be made out of a hard plastic or other weather-resistant material and could display a flocked finish for a realistic effect. In some aspects, each end 34, 36 of the double-faced head 32 could be distinct and separate members from one another, such that rotation of one end 34 has no effect on the other end 36, and vice versa.

The double-faced head 32 could be rotated and could allow one end 34, 36 to be upwardstanding, while the other end 34, 36 is tucked inside the body 12 of the decoy 10. In an aspect, at least one end 34, 36 of the double-faced head 32 can be rotated at least 180 degrees, but could be fully rotatable 360 degrees, around its longitudinal axis. In some aspects, the entire double-faced head 32 is rotatable at least 180 degrees around its longitudinal axis. When a user wishes to invert the decoy 10 from the outer side 14 to the inner side 16 so as to expose a different animal, species, sex, or the like, the user can rotate the double-faced head 32 and invert the body 12, so as to allow the bill and face of the wildfowl shown on the first end 34 to fit within the hollow body 12 while exposing the upwardstanding second end 36. To revert back to the first animal, a user need only to rotate the double-faced head 32 again about 180 degrees and invert the body 12, so as to allow the bill and face of the wildfowl shown on the second end 36 and which was previously upwardstanding, to be tucked within the hollow body 12 and without substantially deforming the three dimensional shape of the body 12.

The rotatable double-faced head 32 could be connected to the body 12 through the use of a variety of securement mechanisms that allow for rotatably securing the double-faced head 32 to the body 12. In some aspects, the double-faced head 32 could be connected to the body 12 through the use of an externally threaded member between the ends 34, 36 that would allow the double-faced head portion 32 to be received and rotated between its ends 34, 36 within a bore 31 having internal threads at the top end 30 of the body 12. This type of screw-mounted double-faced head could help assure that the heads remain secured to the body 12 when throwing the decoys 10 out onto water or grabbing them by the double-faced head 32 to move them. In other aspects, however, the rotatable double-faced head 32 could be connected to the body 12 through the use of other means, such as mating snap-fastening members on the body 12 and head 32.

In some aspects, the rotation of the double-faced head 32 can be controlled and adjusted through the use of friction between the double-faced head 32 and the body 12. This rotation of the double-faced head 32 can be used to not only allow one of the ends 34, 36 of the double-faced head 32 to be tucked into the hollow shell of the body 12 while allowing the other end 34, 36 to remain upwardstanding and visible, but could also be used to allow the upwardstanding and visible end 34, 36 to either appear to be staring straight ahead or to have its head turned to the side. The option of having varying head positions can add a sense of realism to the spread by avoiding the look of duplication between the wildfowl in the spread.

Additional realism to the spread could also be effected through the use of a motor included in the underbelly 40 to create a lifelike motion of the decoy 10 in water.

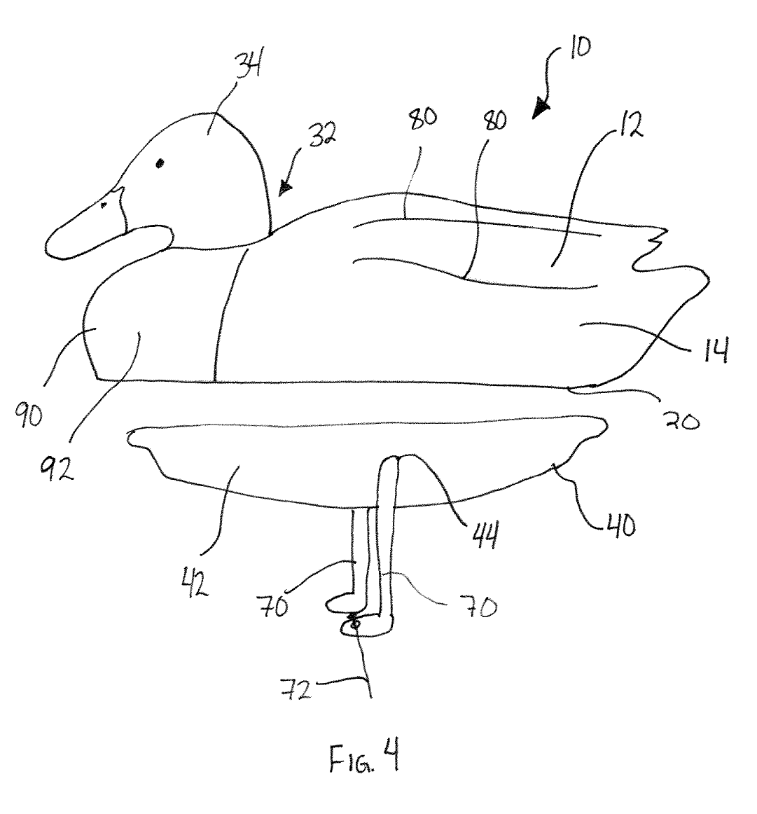

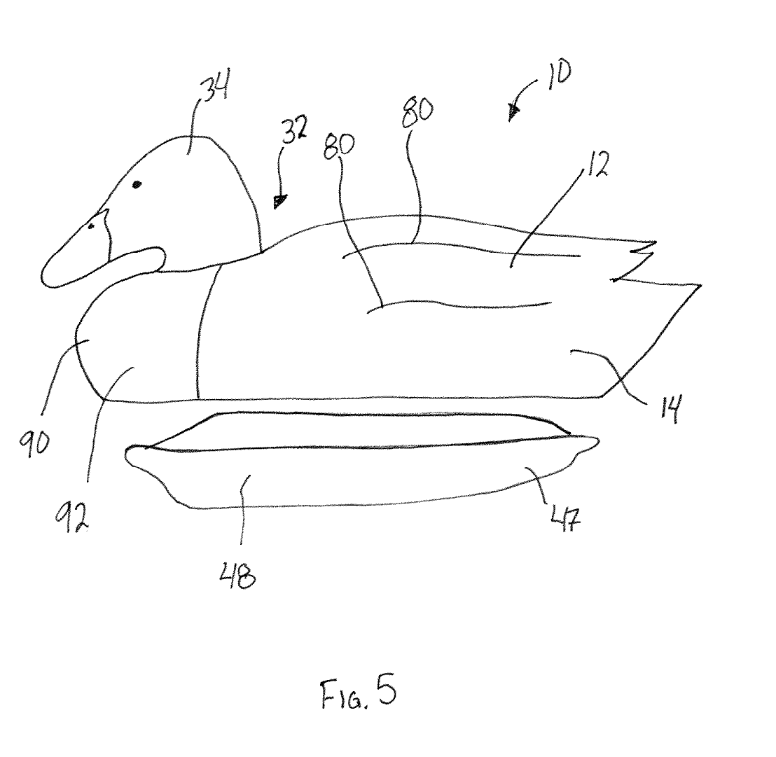

Referring to FIGS. 4 and 5, the decoy 10 can allow the same set of decoys 10 to be used on land (shell or full-bodied) and on water (floating keel) due to the opening 22 at the bottom end 20 of the body 12 that allows for selective attachment of an underbelly 40 having legs 70 and/or an underbelly 47 that floats. The ability to releasably and selectively attach an underbelly 40, 47 allows a single modular decoy to be converted to a land decoy for use in fields or to a water-based decoy for water use.

In the aspect shown in FIG. 4, the decoy 10 is used as a field decoy. A releasably attachable underbelly 40 comprises an underbelly body 42 mimicking the appearance of the underbelly of wildfowl corresponding to body 12 with which the underbelly 40 is to be used. The underbelly 40 can be molded, painted, or dyed to imitate the bottom portion of the animal the decoy 10 is meant to imitate. For example, colors that might be used for the underbelly 40 could be white, gray and black. In some aspects, a separate underbelly 40 can be provided for each of the outer side 14 and the inner side 16 of the decoy 10 that is to be visible, with each separate underbelly 40 matching the outer side 14 and the inner side 16 with which it is to be used. In other aspects, the same underbelly 40 can be used for each side 14, 16 of the decoy 10. In yet other aspects, underbelly 40 can be selectively reversible in a similar manner as the body 12, such that the underbelly 40 can be inverted to match the corresponding surface of the inner side 14 of the outer side 16 of the body 12 that is made visible.

In some aspects, the underbelly 40 could comprise legs and/or feet 70 that are either permanently attached to the body 42 or that are removably attachable to the body 42 to create a full-bodied decoy, if desired. The legs 70 can be colored to imitate the legs of the various waterfowl that the decoy 10 is intended to mimic, for example, black for geese, yellow for certain ducks, green for certain other ducks and orange for yet other species of ducks. The feet 70 could be made out of a hard plastic. Other possible attachments to the underbelly 40 could be wing attachments and tail attachments, as desired. In some aspects, the attachable legs 70 could be interchangeable, enabling different legs and feet 70 to be attached to the body 42 to match the particular wildfowl type of body 12. The attachments may be fabricated to be permanently secured to the body 12 or body 42, may be integrally fabricated therein, or could be releasably attachable.

Attachment of any attachments to the underbelly 40, including the feet 70, could be through known connectors. For example, the underbelly body 42 could comprise attachment apertures 44 that allow a friction fit of the feet 70 therethrough or that could allow a screw-insert of the feet 70 therethrough. In other aspects, the feet 70 could snap into place through the apertures 44. Other forms of known connectors that could allow the feet 70 to be releasably attachable to the underbelly body 42 could also be used. The feet 70 could be hingedly attached in some aspects, allowing the feet 70 to hinge on a vertical pivot to allow a small radius of movement in the wind. This can allow for a more natural look and motion of the decoy 10 providing a sense of safety to birds when being used as a field decoy in the wind.

In some aspects, a support pole or stake 72 can be secured to the decoy body 12 or through a foot 70 for stability of the decoy 10 in wind or on uneven/rough terrain. The support pole or stake 72 can provide the decoy 10 with stability, height off the ground, and/or an anchor to the ground. The stake 72 could act as a stand and could comprise a structure that elevates and supports the decoy 10 above a support surface, such as the ground. The stand 72 may have other configurations, such as a tripod, circular disk-like stand, post, or other supporting structure. In some aspects, the support pole 72 could comprise a stake for use in fields and shallow water. In some cases, more than one support pole 72 could be used with a single decoy 10.

In the aspect shown in FIG. 5, the decoy 10 is used as a floating decoy by using an underbody 46 that floats. In some aspects, the underbelly body 48 can float because of a chamber of air within it. The material making up the underbelly body 48 could also be buoyant in water. This buoyancy could be sufficient to allow the decoy 10 as a whole to float on water.

In some aspects, a relatively small recess in the bottom of the underbelly body 42, 48 can aid in holding the decoy 10 down in the wind and could minimize the slapping noise against water made by some other decoys.

A heavy weighted keel can also be provided to assist the decoy 10 in righting itself upward when thrown, with the underbelly 47 nearest the water and the rotatable double-faced head 32 toward the sky. In some aspects, the floating underbelly 47 has sealed chamber of air for buoyancy and a separate chamber to allow for the addition of weighted material therein to act as ballast with keel.

In some aspects, the underbelly 40, 47 can be made up of a hard plastic that could be inherently weighted or which could have a chamber that is weighted. In other aspects, however, the underbelly 40, 47 could be shipped without being weighted, so as to reduce shipping costs. The underbelly 40, 47 could have at least one hollow chamber that could be fillable with a weighted material, such as sand or any alternative heavy medium. The underbelly 40 could also comprise at least one keel aperture 46 that could be used to insert a heavy medium into the at least one hollow chamber, or to empty the same from the at least one hollow chamber. A plug could also be provided that could releasably seal the keel aperture to keep the heavy medium within the at least one hollow chamber from escaping and to keep water from entering the at least one hollow chamber. In some aspects, the at least one keel aperture 46 could be one and the same as the attachment apertures 44, whereby a user could remove an attachment to reveal an attachment aperture 44 that leads into the at least one hollow chamber, which could then be filled with a medium of choice through the attachment aperture 44. The user could then replace the attachment on the underbelly 40 through the use of the attachment aperture 44, thus acting as a plug for the attachment aperture 44, or could otherwise insert a plug 48 into the attachment aperture 44 when an attachment is not required.

In other aspects, the attachable underbelly 40 could have attachable collapsible legs 70 that can fold up to act as a weighted keel, as shown in FIG. 2. This could allow the use of only one underbelly attachment 40 for use in both land and water.

The at least one hollow chamber in the underbelly 40 can also be used for storing items, such as the attachment feet 70 when not in use. It could also enclose an anchor and/or a spool. The anchor could have a reel mechanism operably connected to the spool for selectively deploying an anchor on a water bottom and anchoring the decoy 10 in the water body. The anchor could in this way allow the decoy 10 to be tethered in a selected floating location for hunting purposes. The underbelly 40 could also have a molded-in cleat for tying off the line in varying depths of water. The hollow chamber could also be used to store the anchor and/or line when not in use.

In some aspects, a plurality of drain apertures 50 can be provided in the sides of the underbelly 40, in order to flood the underbelly and displace the air therein when the decoy 10 is floated and to help drain the underbelly 40 when the decoy 10 is retrieved from the water. Alternatively, both ends of the underbelly 40 can be open to facilitate a free flow of water through the keel underbelly 40, as desired.

The underbelly 40 can be releasably attached to the body 12 through various means.

In an aspect, an elastomeric material may be used between the underbelly 40, 47 and body 12 to releasably attach the underbelly 40, 47 to the body 12. The elastomeric material or band can be stretched around the top portion of the underbelly 40, 47 and/or the opening 22 at the bottom end 20 of the body 12 to securely hold the underbelly 40, 47 and body 12 together. In some aspects, the elastomeric material can be affixed to the body 12, in which case the elastomeric material could be stretch around the underbelly 40, 47, while in other aspects the elastomeric material could be affixed to the underbelly 40, 47 and stretched around the opening 22 at the bottom end of the body 12 to secure the underbelly 40, 47 in place thereto. The elasticity of the elastomeric material could allow it to be removed from the underbelly 40, 47 and/or body 12 so as to detach the underbelly 40, 47 from the body 12. An example of the elastomeric material that could be used would be rubber O-rings that are commercially available.

In another aspect, a resiliently flexible circlip could be disposed in the body 12 to releasably attach the underbelly 40, 47 to the body 12. The resiliently flexible circlip could be made out of, for example, a spring steel wire, and could doubly act as somewhat of an endoskeleton to aid in keeping the three dimensional shape of the decoy body 12. The circlip could allow a snap on connection with a groove located around the top of the underbelly 40, 47. The circlip wire could be embedded within the structure of the body 12, such as within a molded silicone body 12. If the circlip wire is embedded within the structure of the body 12, a reinforcement fabric may be used in conjunction therewith to ensure a greater surface area in securing the wire such that it does not dislodge from the body 12.

In yet other aspects, the body 12 could be secured to the underbelly 40, 47 through the use of a frictional snap-on force and resiliently flexible materials, through screw-insert combinations, or other forms of connectors that can maintain a releasable attachment of the body 12 to the underbelly 40, 47.

The use of an invertible body 12 along with a releasably attachable underbelly 40, 47 that can float can effectively allow the use of a single decoy body to be used to resemble two different animals or birds, and can allow each of the animals represented to be on-the-fly converted and used as all of a land-based shell decoy, a land-based full-bodied decoy, and a water-based full-body decoy. In this way, a sportsman needs to only purchase one set of decoys 10, rather than a set of floating decoys and a separate set of field decoys, if the sportsman wishes to harvest both in water and on land. The modular nature of the decoy 10 and the possibility of attachments can furthermore allow a variety of realistic positions of the animals represented including, but not limited to, lifelike positions such as ‘feeding’, ‘resting’, ‘walking’, ‘guarding/sentry’, ‘sitting’, ‘standing’, ‘wading’, ‘swimming’, ‘chasing’, ‘stretching’, and ‘calling’. These varying positions can add realism and depth to a spread.

In a method of using the decoy 10, a user can change the species, sex, age, seasonal plumage, positioning, etc. of the animal represented on the outer surface 14 of the body 12 and by the first end 34 of the double-faced head 32 to the animal represented on the inner surface 16 of the body 12 and by the second end 36 of the double-faced head 32, by rotating the double-faced head 32 and inverting the resiliently flexible body 12 through the opening 22 at a bottom end 20 of the body 12, whereby the second end 36 of the double-faced head 32 is upwardstanding and is visible along with the second surface 16 of the body 12 and the first end 34 of the double-faced head 32 is somewhat rearward facing and tucked into the hollow shell of the body 12. In some aspects, a user can choose which side of the underbelly 40 would suit the outer side 14 and the inner side 16 of the body 12 that is visible and could invert the underbelly 40 so as to show that side of the underbelly 40. If the decoy 10 is provided with a flap 90, the flap 90 can be tucked behind the body 12 after the body 12 has been inverted and secured in place.

A user can then attach the underbelly 40, 47, if desired, according to its desired application. For example, if a user desires to use the decoy 10 on water, the legs 70 can be detached in some cases, or in other cases, can be folded up. The user can also deploy a weighted cord or anchor. If a user wishes to use the decoy 10 as a full-bodied decoy, the underbelly 40 could be attached to the body 12 and the legs 70 either removably attached to the underbelly or folded down. In some aspects, the weighted cord and/or anchor can be stowed away inside a hollow chamber of the underbelly 47. In some aspects, a stake 72 can be placed through an aperture in one of the legs 70 and into the ground to ensure stability during gusty days. If a user wishes to use the decoy 10 as a shell decoy, the legs 70 can either be removably detached from the underbelly 40 and stored therewithin, or could be folded upward and then the user could invert the underbelly 40 such that the legs 70 are stowed away on the non-visible surface of the underbelly 40. The underbelly 40 could then be attached to the body 12.

To transport the decoy 10, the legs 70 and any other attachments such as a weighted cord and/or anchor can be stored within a hollow chamber of the underbelly 40 or even within the shell of the body 12. This can protect the legs 70 and attachments from damage or loss during transport.

The use of the field conversion decoy 10 can allow for a compressible or collapsible shell body 12 and a rotatable double-faced head 32 that can be converted readily and easily from one species of animal or a given appearance, to another species of animal or given appearance so as to take on a new appearance of the animal the user desires to attract or decoy. The use of an attachable underbelly 40, 47 can allow the decoy 10 to act as a full-bodied decoy, a shell decoy, or a water-based decoy. The modular components of the shell body 12, rotatable double-faced head 32, and attachable underbelly 40, 47 can together give the anatomical appearance of a wildfowl species including a body, head, tail, and feet. They can reduce the plurality of decoys the user needs to carry or transport when desiring to decoy more than one species of water fowl, as well as reduce the cost of a decoy spread by allowing a single decoy 10 to be used in varying scenarios in the field.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A decoy comprising:
a reversible body having a top end and a bottom end with an opening in the bottom end;
an outer side displaying a first animal; and
an inner side displaying a second animal,
wherein the decoy is transformed from displaying the first side and the first animal to displaying the second side the second animal by inverting the reversible body.

2. The decoy of claim 1, wherein the first animal is a different animal than the second animal.

3. The decoy of claim 1, wherein the first animal is a different species than the second animal.

4. The decoy of claim 1, wherein the first animal is the same species as the second animal and the first animal is a different gender than the second animal.

5. The decoy of claim 1, wherein the body is formed from at least one of: silicone; a rubber-based material; a polymer; and a fabric.

6. The decoy of claim 1, wherein the first animal and the second animal are birds.

7. The decoy of claim 6, wherein the first animal and the second animal are waterfowl.

8. The decoy of claim 1, wherein the body is hollow.

9. The decoy of claim 1, wherein the body is formed of a sheet of fabric between the outer side and the inner side.

10. The decoy of claim 9, wherein the outer side is a material applied to the fabric and the inner side is a material applied to the fabric.

11. The decoy of claim 1, wherein an exoskeleton is provided between the inner side and the outer side of the body.

12. The decoy of claim 1, further comprising relief channels in the body.

13. The decoy of claim 12, wherein the relief channels are provided in sides of the body.

14. The decoy of claim 12, wherein the relief channels are provided on an inner side of the body.

15. The decoy of claim 14, wherein the relief channels penetrate through the inner side to the outer side of the body.

16. The decoy of claim 12, wherein the relief channels run horizontally and perpendicular to a curve over a back of the body.

17. The decoy of claim 12, wherein the relief channels run along wings in the body of the decoy.

18. The decoy of claim 1, further comprising a flap at a front of the body.

19. The decoy of claim 18, wherein the flap has a first end connected to the body and a second end unconnected to the body.

20. The decoy of claim 19, wherein the flap display a chest of the first animal and the second animal.

21. The decoy of claim 18, the flap covers an opening in the front end of the body.

22. The decoy of claim 21, wherein the flap is longer than the opening in the front end of the body.

23. The decoy of claim 1, further comprising a head provided at the top end of the body.

24. The decoy of claim 23, wherein the head is a double-faced head with a first end corresponding to the first animal and a second end opposite to the first and corresponding to the second animal.

25. The decoy of claim 24 wherein the first end extends from the outer side and the second end extends from the inner side.

26. The decoy of claim 24, wherein the first end is rotatable and the second end is rotatable.

27. The decoy of claim 26, wherein the first end can be rotated at least 180 degrees and the second end can be rotated at least 180 degrees.

28. The decoy of claim 1, further comprising an underbelly sized to fit through the opening and inside the body of the decoy.

29. The decoy of claim 28, wherein the underbelly is adapted to float.

30. The decoy of claim 28, wherein the underbelly comprises legs.
